(19) United States
(12) Patent Application Publication
(10) Pub. No.: US 2016/0012506 A1
(43) Pub. Date: Jan. 14, 2016

(54) Resident mobile contacts recommendation having a user requested target in their contact lists

(71) Applicant: Apprekon, Inc., San Jose, CA (US)

(72) Inventor: Dinesh Ganti, Hyderabad (IN)

(21) Appl. No.: 14/329,879

(22) Filed: Jul. 11, 2014

(51) Int. Cl. G06Q 30/06; H04W 8/20; H04W 4/02

(52) U.S. Cl. CPC G06Q 30/0613; G06Q 30/0631; H04W 4/02; H04W 8/20

(57) ABSTRACT

The embodiments herein provide a system and method for recommending a resident mobile contact having a target, requested by a user, as a contact in their contact lists. The method includes receiving a request from the user for introduction to the target. Further, the method includes identifying resident mobile contact(s) of the user having the target as a contact in their contact list, where the resident mobile contacts is identified based on one or more tags associated with each mobile contact available in the contact list of the resident mobile contact. Furthermore, the method includes recommending the identified resident mobile contacts having the target as a contact to the user, where the recommendation is provided in accordance to a dynamic weight associated with each resident mobile contact.

### FIELD OF EMBODIMENT

The embodiments herein relate to recommendation systems and more particularly to a mechanism, for recommending at least one resident mobile contact having a target contact details to a user.

### BACKGROUND

Generally, a user starts looking for information about an interested business entrepreneur using a search engine or by contacting a local search services over the phone, web, Short Message Services (SMS), and the like. The user may primarily be concerned about searching a trusted business entrepreneur, which may include significant challenges for the user during decision-making process in terms of trust, reliability, confidence, interested target abilities, and the like. Most of the users prefer to contact friends, relatives, or acquaintances among their circles to gather the information about the trusted business entrepreneur pursuant to the user requirements. For example, the user contacts their close friends or relatives to know about a trusted doctor contact details. The user may have to manually communicate with each contact in their mobile phone contact list to know whether they any information about the interested target.

In order to automate the process, different systems and methods are proposed to use tags to identify contacts and business entrepreneurs. Generally, the contacts of the user can be organized using tags or any form of Metadata, either manually or automatically, to exchange and search for information. By tagging, the user can readily organize their contact lists thereby facilitating the ease of communications with the contacts. The users may need to upload each of their contacts credentials on a server which may involve personal and security issues. The conventional system follows an interleaved mechanism to know whether the business entrepreneur contact details are available in any of the contacts of the user. Further, such systems and methods are restricted to identify only web contacts of the user having information about the business entrepreneur in their contact list and may not be applied to mobile contact stored in contact list of the user mobile phone.

Thus there remains a need of robust and simple system and method for automatically recommending at least one resident contact having a target business entrepreneur contact details in their contact list.

### OBJECT OF EMBODIMENT

The principal object of the embodiments herein is to provide a system and method for recommending one or more resident mobile contacts of a user, having a target requested by the user as a contact in their contact lists. Tags associated with each mobile contact available in the contact list of the one or more resident mobile contacts can be used to determine whether any of the resident mobile contact includes the target as a contact in their contact list.

Another object of the embodiments herein is to provide a tagging mechanism automatically tag each resident mobile contact of a user.

Yet another object of the embodiments herein is to provide a tagging mechanism automatically suggest one or more tags for a mobile contact.

Yet another object of the embodiments herein is to provide a tagging mechanism to identify one or more resident mobile contacts of a user, having one or more targets requested by the user as a contact their contact lists.

Yet another object of the embodiments herein is to provide a mechanism for providing a dynamic weight to each resident mobile contact based on a degree of involvement of the user with each resident mobile contact.

Yet another object of the embodiments herein is to provide a collaborative platform for business entrepreneurs to search, refer, and rewards mobile contacts in response to receiving a lead.

### SUMMARY

Accordingly the embodiments herein provide a method for recommending resident mobile contact(s) to a user using a server. The method includes receiving a request from the user for introduction to a target. Further, the method includes identifying resident mobile contact(s) of the user having the target as a contact in their contact list, where the resident mobile contacts is identified based on one or more tags associated with each mobile contact available in the contact list of the resident mobile contact. Furthermore, the method includes recommending the identified resident mobile contacts having the target as a contact to the user, where the recommendation is provided in accordance to a dynamic weight associated with each resident mobile contact.

Accordingly the embodiments herein provide a system for recommending resident mobile contacts to a user. Further, the system includes a server configured to receive a request from the user for introduction to a target. Further, the server is configured to identify resident mobile contact(s) of the user having the target as a contact in their contact list, where the resident mobile contacts is identified based on one or more tags associated with each mobile contact available in the contact list of the resident mobile contact. Furthermore, the server is configured to recommend the identified resident mobile contacts having the target as a contact to the user, where the recommendation is provided in accordance to a dynamic weight associated with each resident mobile contact.

Accordingly the embodiments herein provide a computer program product including a computer executable program code recorded on a computer readable non-transitory storage medium. The computer executable program code when executed causing the actions including receiving a request from a user for introduction to a target. Further, the computer executable program code when executed causing the actions including identifying resident mobile contact(s) of the user having the target as a contact in their contact list, where the resident mobile contacts is identified based on one or more tags associated with each mobile contact available in the contact list of the resident mobile contact. Furthermore, the computer executable program code when executed causing the actions including recommending the identified resident mobile contacts having the target as a contact to the user, where the recommendation is provided in accordance to a dynamic weight associated with each resident mobile contact.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This embodiment is illustrated in the accompanying drawings, throughout which like reference letters indicate corresponding parts in the various figures. The embodiments herein will be better understood from the following description with reference to the drawings, in which:

FIG. 1 illustrates a high level overview of a system for recommending one or more mobile contact(s) to a user using a server, according to embodiments disclosed herein;

FIG. 2 is block diagram illustrating various modules of a user or acquaintance mobile device, according to embodiments disclosed herein;

FIG. 3 is block diagram illustrating various modules of a server, according to embodiments disclosed herein;

FIG. 4 shows an example illustration of various contact information stored in the server, according to embodiments disclosed herein;

FIG. 5 is block diagram illustrating various modules of a service provider device, according to embodiments disclosed herein;

FIG. 6 is a flow diagram illustrating a method for recommending one or more resident mobile contact(s) to a user using a server, according to embodiments as disclosed herein;

FIG. 7 is a flow diagram illustrating a method for assigning a dynamic weight to each resident mobile contact of a user, according to embodiments as disclosed herein;

FIG. 8 is a flow diagram illustrating a method for tagging each resident mobile contact in a contact list of a user, according to embodiments as disclosed herein;

FIG. 9 shows an example illustration of recommending resident mobile contact to a user in by using example scenario, according to embodiments as disclosed herein;

FIG. 10 is a flow diagram illustrating a method for facilitating a communication session between a user and a resident mobile contact, according to embodiments as disclosed herein;

FIG. 11 is a flow diagram illustrating a method for inserting an offer based on at least one revenue opportunity associated with a target, according to embodiments as disclosed herein;

FIGS. 12a, 12b, 12c, and 12d shows example illustrations of tagging and displaying resident mobile contacts in the contact list of the user, according to embodiments as disclosed herein;

FIGS. 12e and 12f shows example illustrations of searching resident mobile contact using the tag as depicted in the FIG. 12c, according to embodiments as disclosed herein;

FIG. 12g shows example illustration of displaying notifications to the user, according to embodiments as disclosed herein;

FIG. 12h shows example illustrations of displaying rewards to the user, according to embodiments as disclosed herein; and

FIG. 13 illustrates a computing environment implementing the system and methods described herein, according to embodiments as disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

Prior to describing the embodiments in detail, it is useful to provide definitions for key terms and concepts used herein. Unless defined otherwise, all technical and scientific terms used herein have the same meaning as commonly understood by a personal having ordinary skill in the art to which this embodiment belongs.

Resident mobile contact: Refers to a mobile contact residing in a contact list of a user mobile device.

Mobile contact: Refers to a mobile contact resided in a contact list of the resident mobile contact.

Degree of Similarity: May refers to a function of similarity parameters which represents the (often exclusive) right to compute similarity (or substantially similar), or exactness (or substantially exact), and distance among mobile contacts.

Degree of involvement: May refers to a function of involvement parameters which represents the (often exclusive) right to compute involvement of each user based on activities performed over a period of time. The degree of involvement of the user can be used to assign a dynamic weight to each resident mobile contact, which indicates a trust level of the user on each resident mobile contact.

The embodiments herein achieve a method and system recommending one or more resident mobile contacts having a target, requested by a user, as a contact in their contact lists. In an embodiment, the method includes receiving a request from the user for introduction to the target. Further, the method includes identifying resident mobile contact(s) of the user having the target as a contact in their contact list, where the resident mobile contact(s) is identified based on one or more tags associated with each mobile contact available in the contact list of the resident mobile contact. Furthermore, the method includes recommending the identified resident mobile contact(s) having the target as a contact to the user, where the recommendation is provided in accordance to a dynamic weight associated with each resident mobile contact.

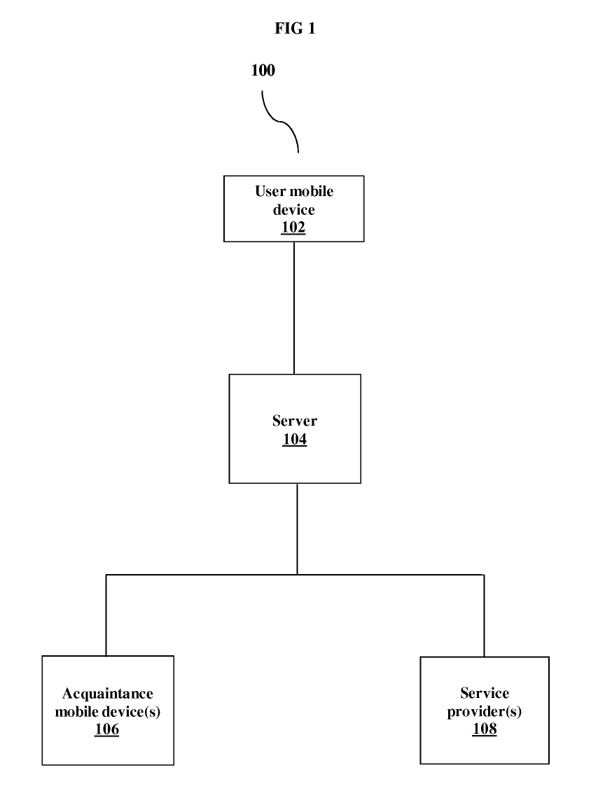

Referring now to the drawings, and more particularly to FIGS. 1 through 13, where similar reference characters denote corresponding features consistently throughout the figures, there are shown preferred embodiments.

FIG. 1 illustrates a high level overview of a system for recommending one or more mobile contact(s) to a user using a server, according to embodiments disclosed herein. As depicted in the FIG. 1, the system includes a user mobile device 102, a server 104, friend or contact mobile device(s) 106, and service provider(s) 108.

In an embodiment, the user mobile device 102 can be configured to include a contact list including various resident mobile contacts. The resident mobile contacts described herein can be the mobile device user acquaintance, friends, family members, colleagues, business entrepreneurs and the like. Each of the resident mobile contact is further associated with the acquaintance mobile device 106. The acquaintance mobile device 106 can further includes a contact list including different mobile contacts. The user and their acquaintance may get registered with the server 104, such as to use various services and features offered by the server 104. Unlike conventional systems, the user and acquaintance provides only basic information about them to the server 104. Note that the server 104 does not include any credentials or confidential information such as user name, user mobile number, email address, and the like associated with the user and acquaintance.

In an embodiment, the server 104 can be configured to assign a tag to identify the information related to the contacts associated with the user and acquaintance. Further, more details related to a method for automatically assigning tags to each contact are described in later paragraphs of the document. Furthermore, the service providers 108 can be configured to integrate with the server 104, such as to provide various services to the user.

The FIG. 1 shows an exemplary overview of the system but, it is to be understood that another embodiment is not limited thereto. Further, the system can include different modules communicating among each other along with other hardware or software components. For example, the component can be, but not limited to, a process running in the electronic device, an executable process, a thread of execution, a program, and/or a computer. By way of illustration, both an application running on an electronic device and the electronic device can be the component.

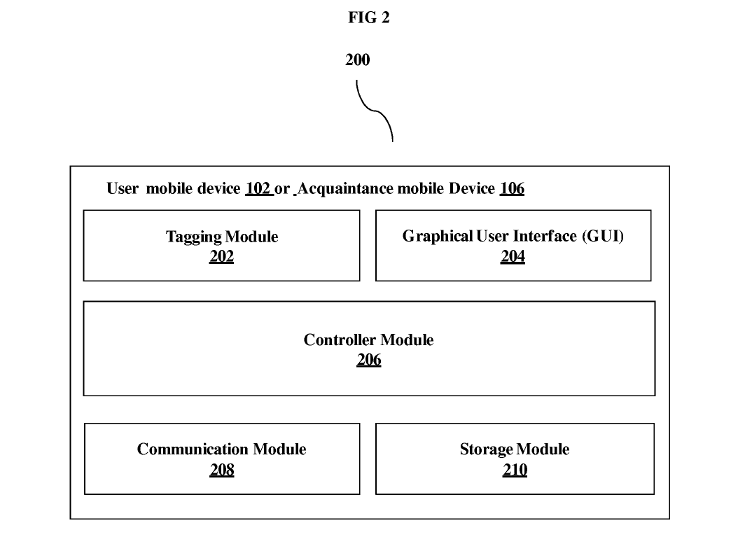

FIG. 2 is block diagram illustrating various modules 200 of a user or acquaintance mobile device, according to embodiments disclosed herein. The user mobile device 102 or acquaintance mobile device 106 includes a tagging module 202, a Graphical User Interface (GUI) 204, a controller module 206, a communication module 208, and a storage module 210.

In an embodiment, the tagging module 202 can be configured to assign tags to each resident mobile contact in the contact list of the user. The tags can be automatically assigned based on the information such as email, name, company details, and the like associated with each resident mobile contact. For example, if the mobile contact includes email address as noname@anydomain.com then a tag can be assigned as “any domain”. The tag can also be manually confirmed by the user. Further, the tagging module 202 can be configured to upload the tags assigned to each mobile contact to the server 104. Unlike conventional systems, only the tags associated with each resident mobile contact is uploaded on the server 104. The credentials or confidential information of each resident mobile contact is stored in the user mobile device 102 itself. Similarly, the acquaintance or resident mobile contacts may also include different mobile contact in contact lists of their acquaintance mobile device 106. Each of the mobile contacts of the resident mobile contacts is also automatically tagged by the tagging module 202.

In an embodiment, the GUI 204 can be configured to provide interface for the user such as to display the resident contact information. The GUI 204 can be configured to display recommendations to the user. For example, the recommendations can be, but not limited to, notifications regarding pending responses for requested information, pending approvals, new auto suggestions, new messages from registered business entities or service providers, new reward points, and so on.

In an embodiment, the controller module 206 can be configured to assign dynamic weight to each resident contact. A degree of involvement of each resident contact with other resident contact with every other resident contact can be computed using a involvement parameter. The similarity parameter described herein can include for example, but not limited to, number of messages sent, number of messages received, number of interactions performed (for example, number of dialed calls, number of received calls, number of missed calls, number of likes, communication within the applications, status information, and the like), proximity, location, success ratio, circle of each resident mobile contact, and the like. The controller module 206 can be configured to receive a request for a target from the GUI 204. The controller module 206 can be configured to identify resident mobile contacts having the target request by the request as a contact in their contact list. The tags associated with each mobile contact available in the contact list of the resident mobile contacts can be used to determine whether any of the resident mobile contact includes the target as a contact in their contact list. For example, if the user provides the request as ‘Dentist’, the controller module 206 search contact list of the resident mobile contacts of the user mobile device 102 and recommend the resident mobile contacts including the dentist as contact in their contact list.

In an embodiment, the communication module 208 can be configured to provide various communication channels to allow the user mobile device to commutate with various devices such as the server 104, the acquaintance mobile devices 106, and the service providers 108. The communication channel can be any suitable networks such as, but not limited to, wireless network, wire line network, public network such as the Internet, private network, general packet radio network (GPRS), local area network (LAN), wide area network (WAN), metropolitan area network (MAN), cellular network, public switched telephone network (PSTN), personal area network, and the like.

In an embodiment, the storage module 210 can be configured to store the resident mobile contact information such as for example, but not limited to, dynamic weights, tags, and so on. Further, the storage module 210 can be configured to include various instructions to allow the communication and control instructions to various modules 200.

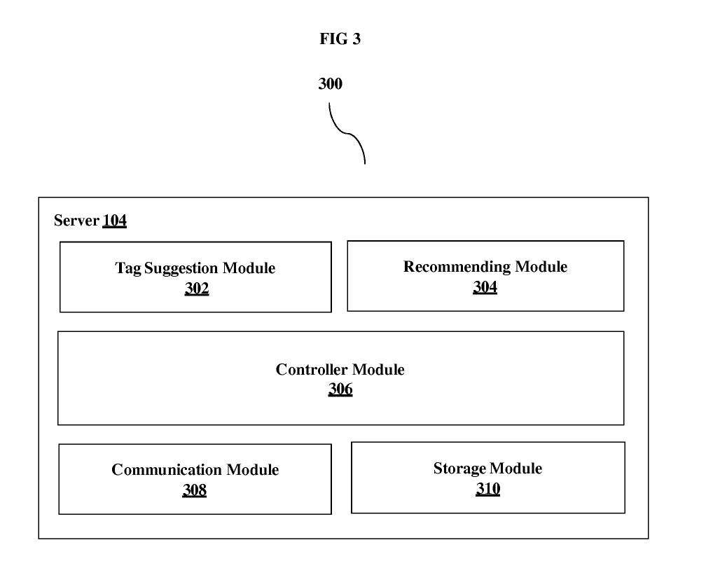

FIG. 3 is block diagram illustrating various modules 300 of a server, according to embodiments disclosed herein. The server 104 can include a tag suggestion module 302, a recommending module 304, a controller module 306, a communication module 308, and a storage module 310.

In an embodiment, the tag suggestion module 302 can be configured to compute a degree of similarity between different mobile contacts based on similarity parameters. The similarity parameters described herein can be for example, but not limited to, proximity, the dynamic weight associated with each resident mobile contact, success ratio, type of tag, circle of each contact, and the like.

Further, the tagging module 302 can be configured to suggest tags to the user based on the computed degree of similarity. For example, when the user tries to store a new mobile contact or tag an existing resident mobile contact in the user mobile device 102, a degree of similarity between the new mobile contact and the mobile contact on the contact list of the resident mobile contact can be computed. In an embodiment, the tags can be suggested based on the computed degree of similarity between the new mobile contact and the mobile contact associated with the contact list of the resident mobile contact of the user.

In an embodiment, the controller module 306 can be configured to identify resident mobile contacts having the target request by the request as a contact in their contact list. The tags associated with each mobile contact available in the contact list of the resident mobile contacts can be used to determine whether any of the resident mobile contact includes the target as a contact in their contact list.

In an embodiment, the recommending module 304 can be configured to generate recommendations for the user. The recommendations can include information about the identified resident mobile contacts having information of the target in their contact lists.

In an embodiment, the communication module 308 can be configured to provide various communication channel to allow the server 104 to communicate with the mobile device such as the user mobile device 102, the acquaintance mobile device 106, and the service provider device 108. The communication channel can be any suitable networks such as for example, but not limited to, wireless network, wire line network, public network such as the Internet, private network, general packet radio network (GPRS), local area network (LAN), wide area network (WAN), metropolitan area network (MAN), cellular network, public switched telephone network (PSTN), personal area network, and the like.

In an embodiment, the storage module 310 can be configured to store information related to resident mobile contact.

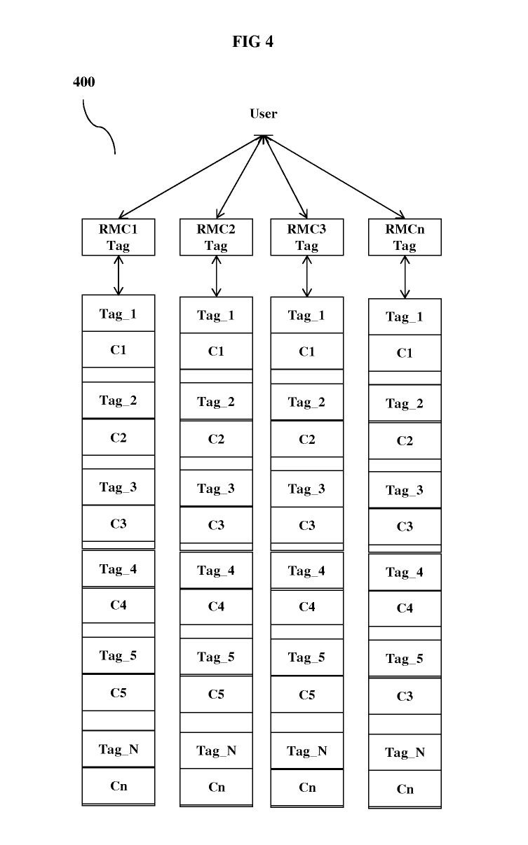

Further, the storage module 210 can be configured to include various instructions to allow the communication and control instructions to various modules 200. Unlike conventional systems, the user and acquaintance provides only basic information such as tags and dynamic weight to the server 104. Note that the server 104 does not include any credentials or confidential information such as user name, user mobile number, email address, and the like associated with the user and acquaintance. Further, an example illustration of the basic information of the user stored in the server 104 is described in conjunction with the FIG. 4.

FIG. 4 shows an example illustration 400 of various contact information stored in the server 104, according to embodiments disclosed herein. As shown in the FIG. 4, the contacts RMC1, RMC2, RMC3, and RMCn represent the resident mobile contacts stored in the user mobile device 102. The tags associated with each contact can be stored using a hash function or hash table. The hash function can be used to correlate the tags associated with various users, such as to facilitate the server 104 to identify the target using the tags. The tag associated with mobile contact of each resident mobile contact is also stored in the server 104. The server 104 can be configured to use the tags such as to identify the availability of the target in the contact lists of the resident mobile contacts of the user.

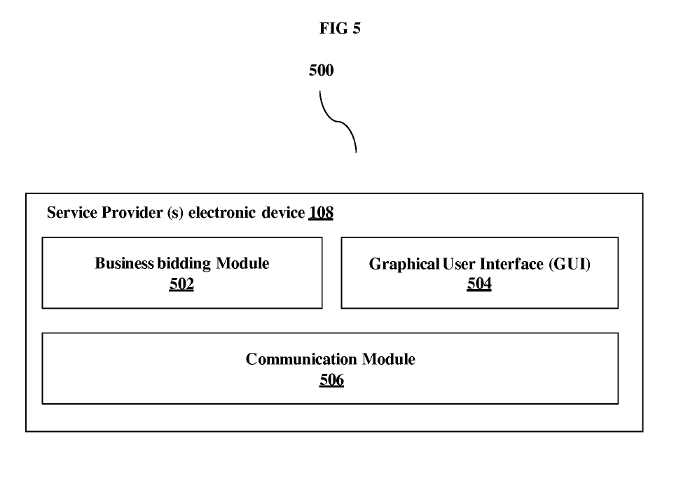

FIG. 5 is block diagram illustrating various modules of a service provider device, according to embodiments disclosed herein. The service provider(s) device 108 includes a business bidding module 502, a GUI module 504, and a communication module 506.

In an embodiment, the business bidding module 502 can be configured to place bids for inserting an offer corresponding to the request provided by the user. The business entrepreneurs can track the revenue opportunities associated with each of the target to bid for placing the offer.

In an embodiment, the GUI 504 can be configured to a user interface to enable the service provider to bid, place ads, and update the business information. The communication module 506 can be configured to provide a communication channel to allow the service provider device 108 to communicate with the user mobile device 102, the server 104, and the acquaintance mobile devices 106.

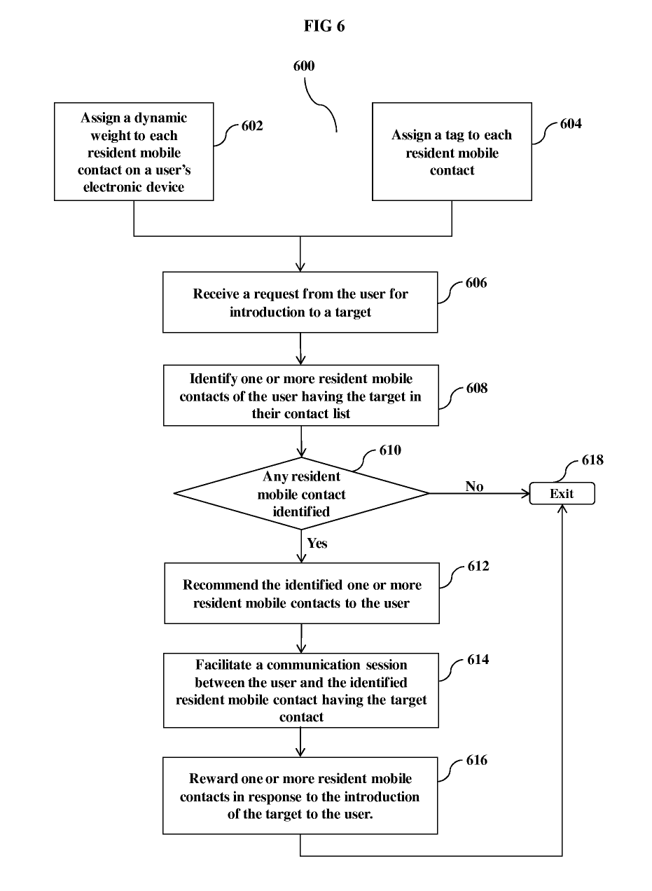

FIG. 6 is a flow diagram illustrating a method 600 for recommending the resident mobile contacts to a user using the server 104, according to embodiments as disclosed herein. In an embodiment, at step 602, the method 600 includes assigning a dynamic weight to each resident mobile contact in the contact list of the user. A degree of involvement of the user with each resident mobile contact can be computed using the involvement parameter, such as to assign the weight to the user. The involvement parameter described herein can include for example, but not limited to, number of messages sent, number of messages received, number of interactions performed, proximity, location, success ratio, circle of each resident mobile contact, and the like. The degree of involvement of the user can be used to assign the dynamic weight to each resident mobile contact, which indicates a trust level of the user on each resident mobile contact. For example, if the user communicates more with a RMC1 more than the RMC2 then the RMC1 can have more weight compared to the RMC2, which indicates the trust factor of user on the RMC1 is more compared to the RMC2. The weights assigned to each mobile contact is dynamic in nature, as the involvement of the user may vary which may the trust level of one resident mobile contact compared to the other resident mobile contact. Further, the dynamic weights of each resident mobile contact can be stored locally on the user mobile device 102.

At step 604, the method 600 includes assigning tags to each of the resident mobile contact in the contact list of the user. The tags can be assigned automatically to each resident mobile contact by identifying information associated with each resident mobile contact (for example, name, email ID, business card, and so on). Further, the tags assigned to each resident mobile contact can be stored remotely on a server 104. Note the server 104 can be configured to store only the tags information of the mobile contact and does not store any credentials or confidential information of the mobile contacts of the user.

At step 606, the method 600 includes receiving a request from the user for introduction to a target. For example, if the user is looking for a plumber then the user can submit the request as ‘plumber’ through to the server 104.

At step 608, the method 600 includes identifying the resident mobile contacts having the target contact details in their contact list. The method 600 allows the server 104 to identify the resident mobile contacts the target as a contact in their contact lists using the tags stored on the server 102. The server 104 may map the stored tags with the target to identify the resident mobile contacts having the target as contact in their contact list.

At step 610, the method 600 includes determining whether any resident mobile contact is identified in the user's contact lists having the target contact details. At step 610, the method 600 includes recommending the identified resident mobile contacts to the user through notifications in response to determining that one or more resident mobile contacts including the target as contact in their contact list. The method 600 allows the user electronic device 102 to display the recommendations including the information about the identified resident contact to the user based on the dynamic weight associated with each resident mobile contact.

At step 614, the method 600 includes facilitating a communication session between the user and the identified the resident mobile contact. The method 600 allows the user to user to initiate a real-time communication session (for example, an on-line chat) or a non-real time communication session (for example, an off-line chat) to get introduced or refer to the target contact details.

At step 616, the method 600 includes rewarding the identified resident mobile contacts in response to introduction of the targets to the user. The method 600 allows the server to track the introductions provided by each resident mobile contact and notify the service providers 108 about the referral. For example, a resident mobile contact RMC2 of the user introduces car wash service information stored in their contact list to the user on getting a request from the user. The car wash service provider gets notified about the referral provided by the RMC2. The car wash service provider can reward the RMC2 in response to introduction of the targets to the user or based on actually getting the lead. Furthermore, the method stops at step 618.

The various actions, acts, blocks, steps, and the like in method 600 may be performed in the order presented, in a different order or simultaneously. Further, in some embodiments, some actions, acts, blocks, steps, and the like may be omitted, added, modified, skipped, and the like without departing from the scope of the embodiment.

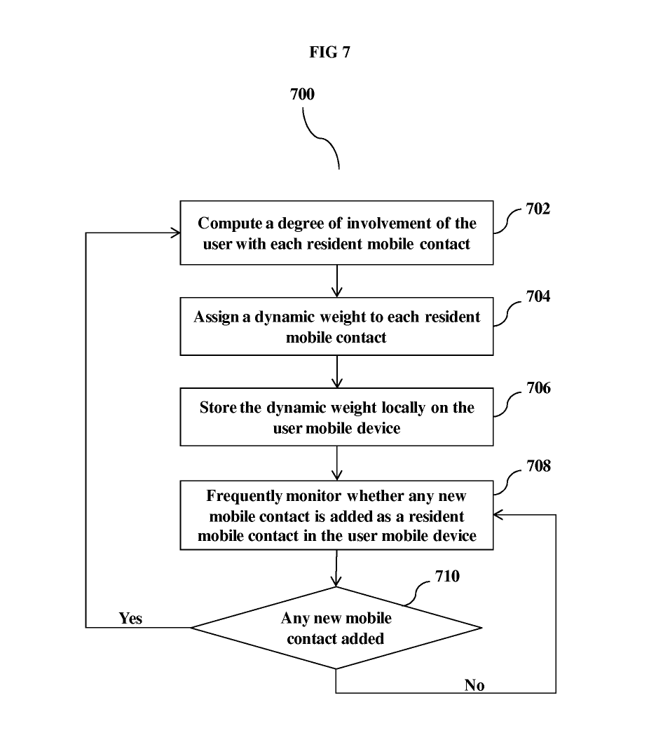

FIG. 7 is a flow diagram illustrating a method 700 for assigning a dynamic weight to each resident mobile contact of a user, according to embodiments as disclosed herein. At step 702, the method 700 includes computing the degree of involvement of the user with each resident mobile contact. The degree of involvement can be assigned to each resident mobile contact by using the involvement parameters associated with the user. The involvement parameters described herein can be for example, but not limited to, number of messages sent, number of messages received, number of interactions performed with each of the resident mobile contact (for example, number of dialed calls, number of received calls, number of missed calls, number of likes, communication within the applications, status information, and the like), proximity of each resident mobile contact to the user, location, success ratio (for example, referral success of each resident mobile contact to the user), and circle of each mobile contact, and so on.

At step 704, the method 700 includes assigning the dynamic weight to each resident mobile contact of user based on the computed degree of involvement. For example, if the degree of involvement of the user with a contact is more, more dynamic weight is assigned to that contact. For example, if a user ‘X’ has a resident mobile contact ‘Y’ then the dynamic weight of Y with respect to X can be given as:

W(Y, X)=Degree of Similarity Function [Location, Proximity(YX), Success(Y)]

At step 706, the method 700 includes storing the assigned dynamic weights locally on the user's mobile device 102. At step 708, the method 700 includes frequently monitoring whether any new mobile contact is added in the user mobile device 102. At step 710, the method 700 includes repeating the steps 702 to 710 in response determining any new mobile contact.

The various actions, acts, blocks, steps, and the like described in the method 700 may be performed in the order presented, in a different order or simultaneously. Further, in some embodiments, some actions, acts, blocks, steps, and the like may be omitted, added, modified, skipped, and the like without departing from the scope of the embodiment.

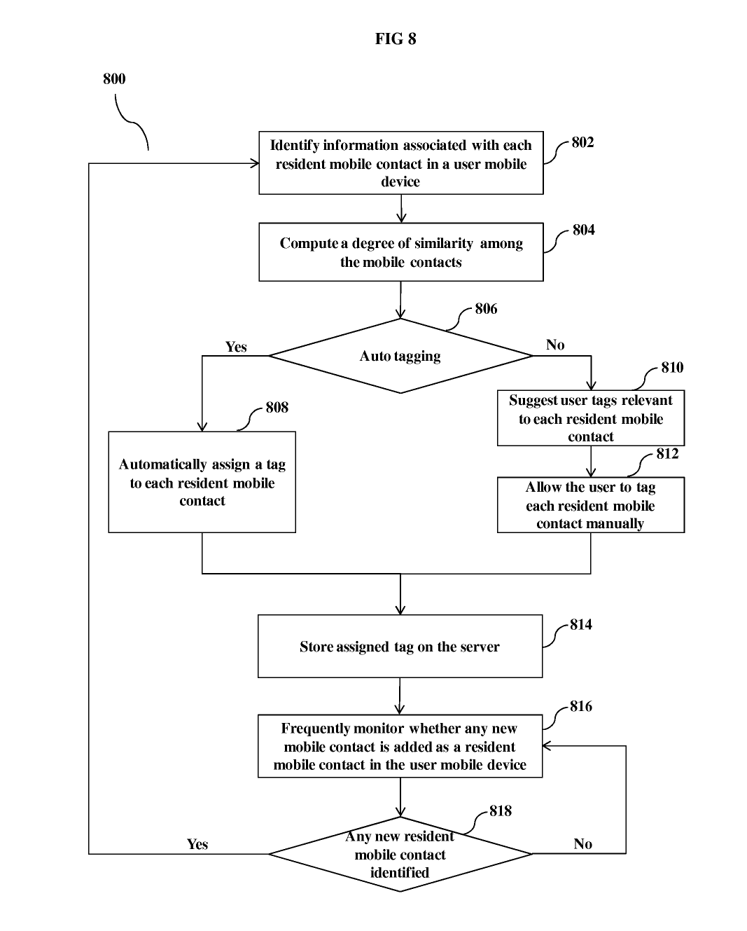

FIG. 8 is a flow diagram illustrating a method 800 for tagging each resident mobile contact in a contact list of a user, according to embodiments as disclosed herein. In an embodiment, at step 802, the method 800 includes identifying information associated with each resident mobile contact in the contact list of the user. The information associated with each resident mobile contact can be for example, but not limited to, email ID, business details, and alternate contact numbers, and so on associated with each resident mobile contact.

At step 804, the method 800 includes a degree of similarity among the mobile contacts. The method 800 allows the server 104 to compute the degree of similarity between different mobile contacts based on similarity parameters. The similarity parameters described herein can be for example, but not limited to, proximity, the dynamic weight associated with each resident mobile contact, success ratio, type of tag, circle of each contact, and the like.

At step 806, the method 800 includes determining the type of tag (for example, manual tag or auto tag) to be added to each resident mobile contact. The method 800 allows the user to detect the type of tag that can be added to each resident mobile contact. For example, the GUI 204 provides options to the user to select the type of the tag.

At the step 808, the method 800 includes automatically assigning the tag to each resident mobile contact based on the information associated with the resident mobile contact and computed degree of similarity. At the step 806, if the user selects manual tagging, the method 800 includes suggesting the user with tags that are relevant to the resident mobile contact based on the computed degree of similarity of each resident contact with the user. In an embodiment, the degree of similarity can be computed using similarity parameters associated with each mobile contact in the contact lists of each resident mobile contact. For example, a user ‘A’ tries to tag a contact ‘C’ and contacts C1, C2 and C3 are the resident mobile contacts of the user ‘A’. The tags suggested for the contact ‘C’ are ‘T1’ from contact ‘C1’, ‘T2’ from contact ‘C2’, and ‘T3’ from contact ‘C3’. Further, the degree of similarity computed as

W(T1, A)=Function [W(C1,A), T1 is user/auto created, source of T1, success(T1)]

In an embodiment, the user can be allowed to set the tags as public or private or opened up to a custom set of contacts. In an embodiment, a single contact in the user mobile device can take multiple tags. In an embodiment, same tag can be assigned to multiple contacts.

At step 812, the method 800 includes allowing the user to tag each resident mobile contact manually using new or suggested tags. The user can select or de-select the tags that are suggested to each resident mobile contact. For example, for a resident mobile contact C12, the tags suggested can be T1, T2 and T3. The user may select the tags T1, T3 and may de-select the tag T2. Hence, for the resident mobile contact C12 tags associated are T1, and T3. In an embodiment, the user can also manually enter the tags to a resident mobile contact based on user's interests.

At step 814, the method 800 includes storing the assigned tags on the server 104. The method 800 allows the storage module 310 to store the assigned tags on the server 104. At step 816, the method 800 includes frequently monitoring whether any new mobile contact is added as a resident mobile contact in the user mobile device 102.

At step 818, the method 800 includes repeating the steps 802 to 818 in response to determining that a new mobile contact is added as a resident mobile contact in the user mobile device 102.

The various actions, acts, blocks, steps, and the like described in the method 800 may be performed in the order presented, in a different order or simultaneously. Further, in some embodiments, some actions, acts, blocks, steps, and the like may be omitted, added, modified, skipped, and the like without departing from the scope of the embodiment.

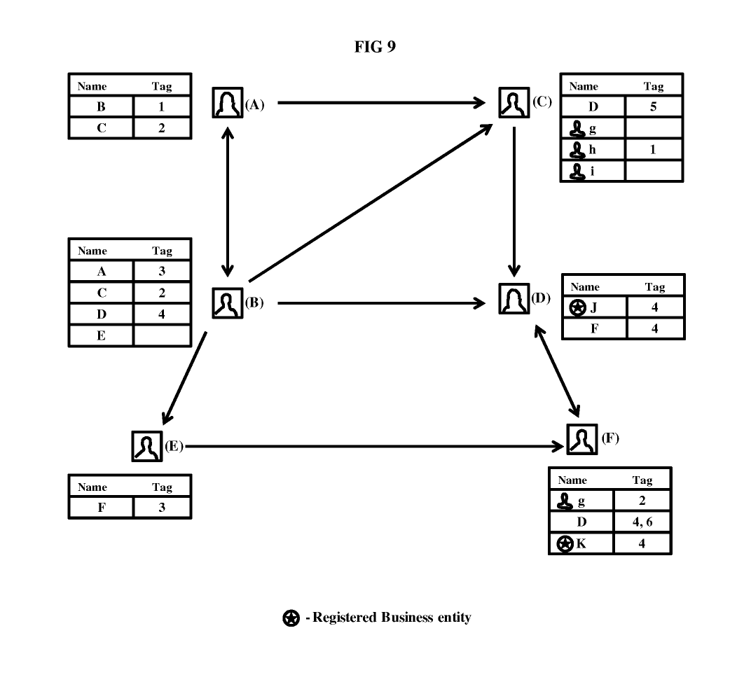

FIG. 9 shows an example illustration of recommending resident mobile contact to a user in by using example scenario, according to embodiments as disclosed herein. Consider, A, B, C, D, E, and F are the users connected with the server 104. As depicted in the FIG. 9, the contacts of A are B and C. Further in A contact list, B is tagged with a tag 1, and C is tagged with a tag 2. Similarly, the contacts of each user B, C, D, E, and F are depicted in the FIG. 9 along with their tags.

Consider that the user A adds a new contact D. The possible tags suggested for D are 5 from C, 4 from B and F, 6 from F. Further, the dynamic weight between each tag and the user A is calculated and recommendation(s) are suggested to the user A. degree of similarity (W) can be computed between the tag 5 associated with contact D of the resident contact C and the user A as:

W(5, A)=Function [W(C, A), 5 is user/auto created, source of 5 Proximity(CA), Success(5)]

Where, W(C, A)=Function [Location, Proximity(CA), Success(C)]

Similarly, the degree of similarity between the tag 4 associated with contact B of the resident contact C also computed Based on the degree of similarity, recommendations are delivered to the user ‘A’ mobile device.

Further, consider the user A is searching for tag 4. When the user A enters 4, the server 104 searches for possible recommendations. Both B and C have the tag 4 in their contacts. Further, the search recommendations are provided by calculating W (B, A) and W (C, A).

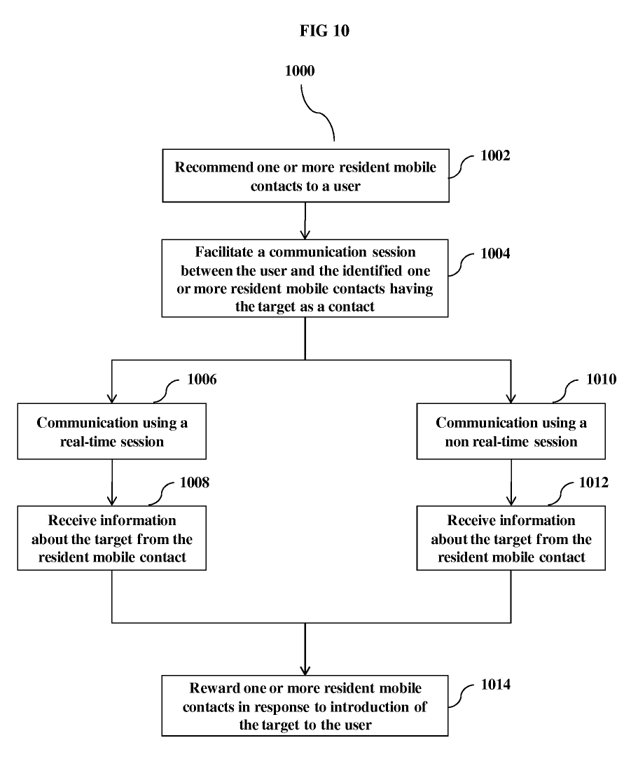

FIG. 10 is a flow diagram illustrating a method 1000 for facilitating a communication session between a user and a resident mobile contact, according to embodiments as disclosed herein. At step 1002, the method 1000 includes recommending the resident mobile contacts to a user. The method 1000 allows the server 104 to recommend the resident mobile contacts to the user by sorting the identified resident mobile contacts based on the dynamic weight associated with each contact.

At step 1004, the method 1000 includes facilitating a communication session between the user and the identified resident mobile contacts having the target contact details. The method 1000 allows the communication module 208 to facilitate a communication session between the user and the identified resident mobile contacts.

At step 1006, the method 1000 includes allowing the user to communicate with the identified resident contact using a real-time communication session. For example, the real-time session can be an on-line chat between the user and the resident mobile contact. The method 1000 allows the communication module 208 to facilitate the real-time communication session between the user and the identified resident mobile contacts such as to get introduced to the target. At step 1008, the method 1000 includes receiving the information, such as contact number and name, about the target from the resident mobile contacts.

At step 1010, the method 1000 includes allowing the user to communicate with the identified resident contact using a non real-time session. For example, the non real-time session can be an off-line chat between the user and the resident mobile contact. The method 1000 allows the communication module 208 to facilitate a non real-time communication session between the user and the identified resident mobile contacts. At step 1012, the method 1000 includes receiving the information, such as contact number and name, about the target from the resident mobile contacts.

At step 1014, the method 1000 includes rewarding the identified resident mobile contacts in response to the introduction of the target to the user. The method 1000 allows the server 104 to reward the identified resident mobile contacts in response to introduction or getting actually getting the lead to the target.

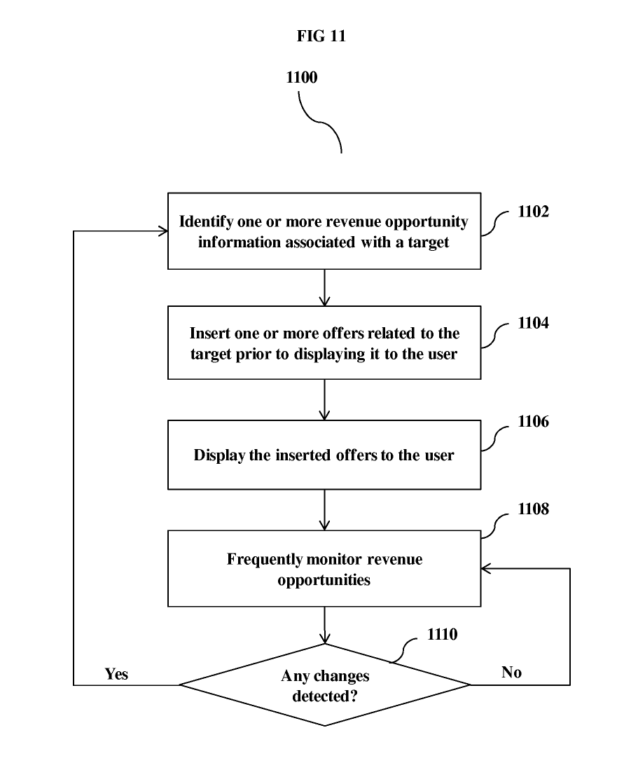

FIG. 11 is a flow diagram illustrating a method 1100 for inserting an offer based on at least one revenue opportunity associated with a target, according to embodiments as disclosed herein. At step 1102, the method 1100 includes identifying revenue opportunities associated with the targets. The method 1100 allows the server 104 to identify the revenue opportunities associated with the target prior to displaying the sorted recommendations to the user.

At step 1104, the method 1100 includes inserting offer(s) related to the target prior to displaying the sorted recommendations to the user. The method 1100 allows the server 104 to insert the offers related to the target prior to displaying it to the user. At step 1106, the method 1100 includes displaying the recommendations along with inserted offers to the user.

At step 1108, the method 1100 includes frequently monitoring the revenue opportunities (for example, any updating of opportunities change in seasons, discounts, and so on) available with the target. At step 1110, if any changes detected in the revenue opportunities available, the method 1100 includes repeating the steps 1102 to 1110.

The various actions, acts, blocks, steps, and the like described in the method 1100 may be performed in the order presented, in a different order or simultaneously. Further, in some embodiments, some actions, acts, blocks, steps, and the like may be omitted, added, modified, skipped, and the like without departing from the scope of the embodiment.

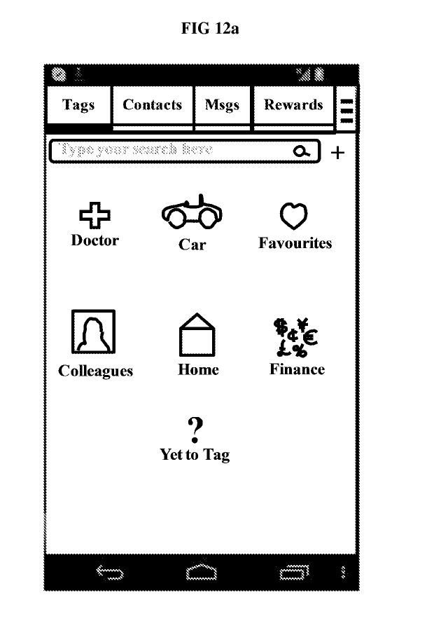

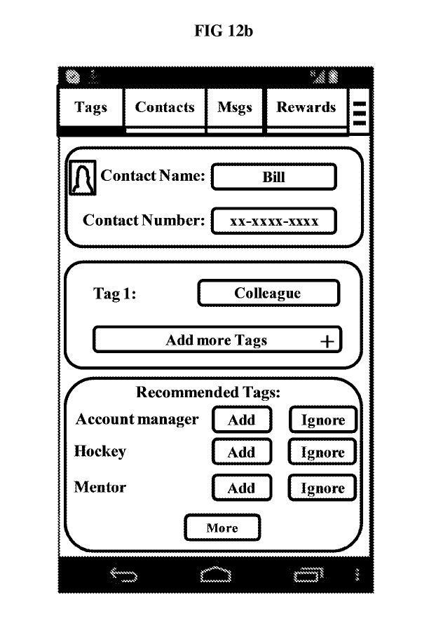

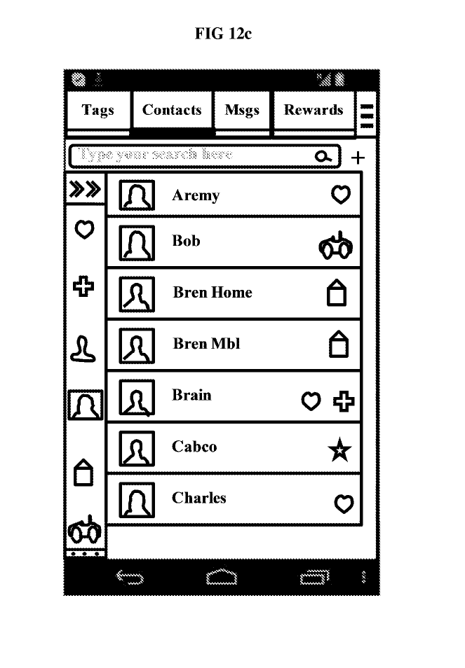

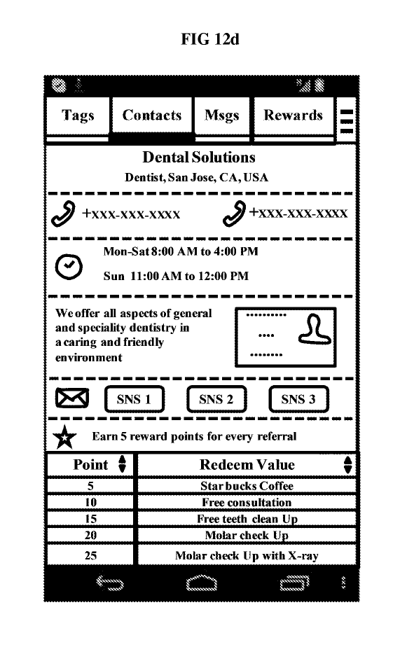

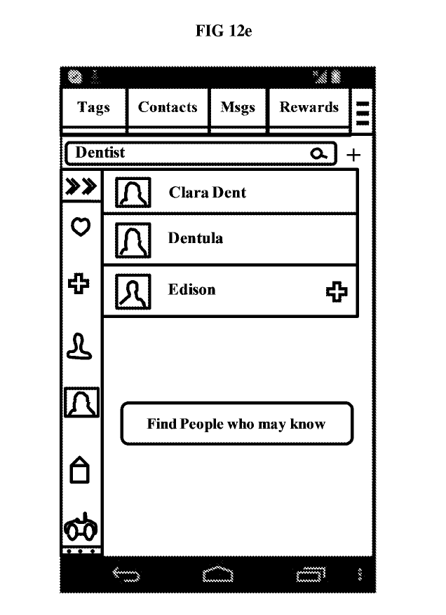

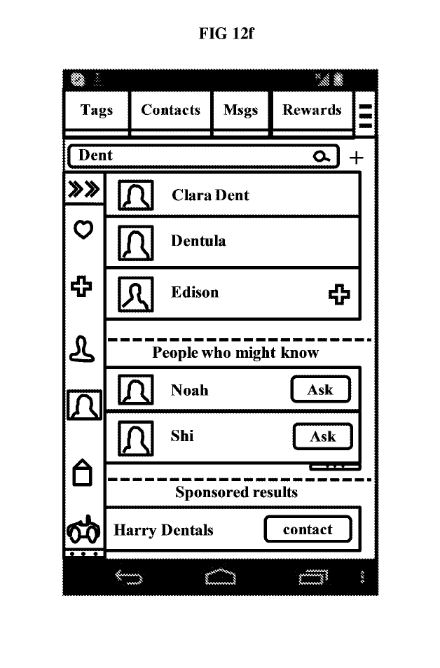

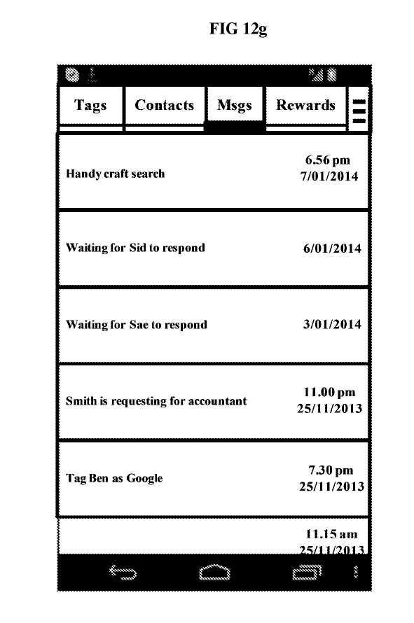

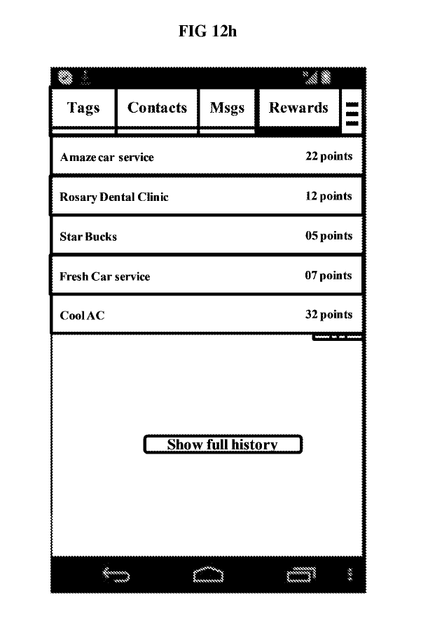

FIGS. 12a, 12b, 12c, and 12d shows example illustrations of tagging and displaying resident mobile contacts in the contact list of the user, according to embodiments as disclosed herein. As depicted in FIG. 12a, the resident mobile contacts that are available in the contact list of the user can be categorized into different tag groups as Doctor, Car, Favorites, and Colleagues, and so on.

FIG. 12b depicts an example embodiment of tagging a resident contact ‘Bill’ manually by the user. As shown in figure, a tag ‘Colleague’ is added to the contact “Bill”. Further, the recommended tags can be displayed below, which the user can add or ignore the tags. For example, the tag ‘account manager’ can be added along with the tag colleague.

FIG. 12c depicts an example embodiment of the resident mobile contacts after tagging. As depicted in the figure, tag symbols are provided at each contact. All the tag categories are provided beside the contacts to allow the user to easily create a tag or assign tag by dragging the tag beside the contact.

FIG. 12d depicts an example embodiment of a business card of a registered business entity. A business entity can be displayed along with the rewards that are provided on referring to a user.

FIGS. 12e and 12f shows example illustrations of searching resident mobile contact using the tag as depicted in the FIG. 12c, according to embodiments as disclosed herein. The FIG. 12e depicts that the user enters the request as ‘Dentist’. The controller module provides resident contacts as recommendations, which includes a tag as dentist for at least one contact in their contact lists. Hence, the results ‘Clara Dent’, ‘Dentula’ and ‘Edison’ are sponsored. Further, an option to find people who may know the contact of the Dentist can also be provided.

The FIG. 12f depicts the recommendations that are provided by the server 104 on receiving a request from the user. The recommendations include the contact information of Noah, Shi who are the resident mobile contacts of the user. The recommendations can also include the sponsored results for example, service providers 108 that are registered with the server (Harry Dentals) 104.

FIG. 12g shows example illustration of displaying notifications to the user, according to embodiments as disclosed herein. The FIG. 12g depicts notifications that are received by the user for introduction to the target. The notifications can include for example, but not limited to, the requests that are sent to the resident mobile contacts to get target information, requests that are received from other resident mobile contacts, Business contacts information and so on.

FIG. 12h illustrates an example embodiment of displaying rewards to a user in user mobile device, according to embodiments as disclosed herein. The FIG. 12h depicts reward points earned by the user. For example, the total reward points that are earned from the Amaze car service are 22.

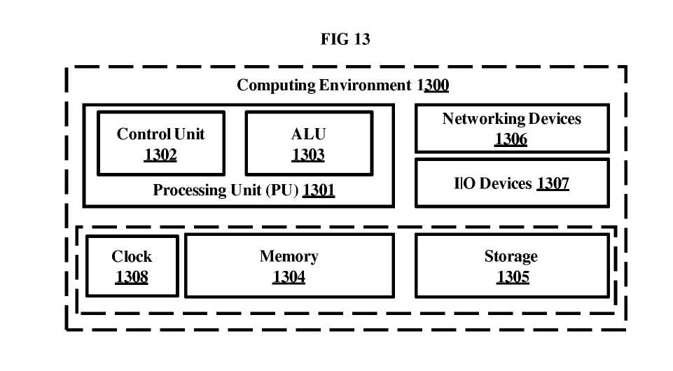

FIG. 13 illustrates a computing environment implementing the system and methods described herein, according to embodiments as disclosed herein. As depicted in the figure, the computing environment 1300 includes at least one processing unit 1501 that is equipped with a control unit 1302 and an Arithmetic Logic Unit (ALU) 1303, a memory 1304, a storage unit 1305, plurality of networking devices 1306 and a plurality Input output (I/O) devices 1307. The processing unit 1301 is responsible for processing the instructions of the algorithm. The processing unit 1301 receives commands from the control unit 1302 in order to perform its processing. Further, any logical and arithmetic operations involved in the execution of the instructions are computed with the help of the ALU 1303.

The algorithm comprising of instructions and codes required for the implementation are stored in either the memory unit 1304 or the storage 1305 or both. At the time of execution, the instructions may be fetched from the corresponding memory 1304 and/or storage 1305, and executed by the processing unit 1301.

In case of any hardware implementations various networking devices 1307 or external I/O devices 1306 may be connected to the computing environment to support the implementation through the networking unit and the I/O device unit. The embodiments disclosed herein can be implemented through at least one software program running on at least one hardware device and performing network management functions to control the network elements.

The embodiments disclosed herein can be implemented through at least one software program running on at least one hardware device and performing network management functions to control the elements. The elements shown in FIGS. 1 and 13 include blocks which can be at least one of a hardware device, or a combination of hardware device and software module.

The embodiment disclosed herein specifies a method and system for recommending one or more resident mobile contacts of a user, having a target requested by the user as a contact in their contact lists. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for recommending at least one resident mobile contact to a user using a server, the method comprising:
receiving at least one request from said user for introduction to at least one target;
identifying at least one resident mobile contact of said user having said at least one target in at least one contact list, wherein said at least one resident mobile contact is identified based on at least one tag associated with each mobile contact available in said at least one contact list of said resident mobile contact; and
recommending said at least one identified resident mobile contact having said at least one target to said user, wherein said recommendation is provided in accordance to at least one dynamic weight associated with each said resident mobile contact.

2. The method of claim 1, wherein said method further comprises:
computing a degree of involvement of said user with each said resident mobile contact, wherein said degree of involvement is computed using at least one involvement parameter associated with said user;
assigning said dynamic weight to each said resident mobile contact based on said degree of involvement of said user with each said resident mobile contact; and
storing said at least one dynamic weight associated with each said resident mobile contact locally on an mobile device of said user.

3. The method of claim 1, wherein said involvement parameter comprises at least one of: number of messages sent, number of messages received, number of interactions performed, proximity, location, success ratio, and circle of each said resident mobile contact.

4. The method of claim 1, wherein said method further comprises:
identifying information associated with each said resident mobile contact;
automatically assigning said at least one tag to each said resident mobile contact based on said information; and
storing said at least one tag remotely on said server.

5. The method of claim 1, wherein said method further comprises:
receiving a new mobile contact on said at least one contact list associated with said user;
computing a degree of similarity between said new mobile contact with each said mobile contact in at least one contact list of each said resident mobile contact, wherein said degree of similarity is computed using at least one similarity parameter associated with each said mobile contact in at least one contact list of said each said resident mobile contact; and
suggesting said at least one tag associated with said at least one contact in at least one contact list of said at least one resident mobile contact based on said degree of similarity.

6. The method of claim 5, wherein said at least one similarity parameter comprises at least one of: proximity, said dynamic weight associated with each said resident mobile contact, success ratio, type of said at least one tag, and said circle of each said contact.

7. The method of claim 1, wherein recommending said at least one identified resident mobile contact having said at least one target to said user comprising:
generating said at least one recommendation for said user, wherein said at least one recommendation comprises said at least one identified resident mobile contact having said at least one target;
sorting said at least one recommendation based on said at least one dynamic weight associated with said at least one identified resident mobile contact; and
displaying said at least one recommendation on said mobile device of said user.

8. The method of claim 7, wherein said method further comprises:
identifying at least one revenue opportunity associated with said at least one target prior to displaying said at least one recommendation to said user; and
inserting at least one offer related to said at least one target based on said at least one revenue opportunity prior to displaying said at least one recommendation to said user.

9. The method of claim 7, wherein said at least one recommendation comprises a location package including said at least one identified resident mobile contact having said at least one target.

10. The method of claim 1, wherein said method further comprising:
facilitating a real-time communication session between said user and said at least one identified resident mobile contact having said at least one target in their at least one contact list; and
receiving contact information associated with said at least one target from said at least one identified resident mobile contact, wherein said contact information is used to introduce said at least one target to said user during said real-time communication session.

11. The method of claim 10, wherein said real-time communication session comprises at least one online chat session.

12. The method of claim 10, wherein said method further comprises rewarding said at least one resident mobile contact in response to said introduction of said at least one target to said user.

13. The method of claim 1, wherein said method further comprising:
facilitating a non-real-time communication session between said user and said at least one identified resident mobile contact having said at least one target in their at least one contact list; and
receiving contact information associated with said at least one target from said at least one identified resident mobile contact, wherein said contact information is used to introduce said at least one target to said user during said non-real-time communication session.

14. The method of claim 13, wherein said non-real-time communication session comprises at least one of offline chat session.

15. The method of claim 13, wherein said method further comprises rewarding said at least one resident mobile contact in response to said introduction of said at least one target to said user.

16. A system for recommending at least one resident mobile contact to a user, the system comprising a server configured to:
receive at least one request from said user for introduction to at least one target;
identify at least one resident mobile contact of said user having said at least one target in at least one contact list, wherein said at least one resident mobile contact is identified based on at least one tag associated with each mobile contact available in said at least one contact list of said resident mobile contact; and
recommend said at least one identified resident mobile contact having said at least one target to said user, wherein said recommendation is provided in accordance to at least one dynamic weight associated with each said resident mobile contact.

17. The system of claim 16, wherein said server is further configured to:
compute a degree of involvement of said user with each said resident mobile contact, wherein said degree of involvement is computed using at least one involvement parameter associated with said user;
assign said dynamic weight to each said resident mobile contact based on said degree of involvement of said user with each said resident mobile contact; and
store said at least one dynamic weight associated with each said resident mobile contact locally on an mobile device of said user.

18. The system of claim 16, wherein said involvement parameter comprises at least one of: number of messages sent, number of messages received, number of interactions performed, proximity, location, success ratio, and circle of each said mobile contact.

19. The system of claim 16, wherein said server is further configured to:
identify information associated with each said resident mobile contact;
automatically assign said at least one tag to each said resident mobile contact based on said information; and
store said at least one tag remotely on said server.

20. The system of claim 16, wherein said server is further configured to:
receive a new mobile contact on said at least one contact list associated with said user;
compute a degree of similarity between said new mobile contact with each said mobile contact in at least one contact list of each said resident mobile contact, wherein said degree of similarity is computed using at least one similarity parameter associated with each said mobile contact in at least one contact list of said each said resident mobile contact; and
suggest said at least one tag associated with said at least one contact in at least one contact list of said at least one resident mobile contact based on said degree of similarity.

21. The system of claim 20, wherein said at least one similarity parameter comprises at least one of: proximity, said dynamic weight associated with each said resident mobile contact, success ratio, type of said at least one tag, and said circle of each said contact.

22. The system of claim 16, wherein recommend said at least one identified resident mobile contact having said at least one target to said user comprises:
generate said at least one recommendation for said user, wherein said at least one recommendation comprises said at least one identified resident mobile contact having said at least one target;
sort said at least one recommendation based on said at least one dynamic weight associated with said at least one identified resident mobile contact; and
display said at least one recommendation on said mobile device of said user.

23. The system of claim 21, wherein said server is further configured to:
identify at least one revenue opportunity associated with said at least one target prior to display said at least one recommendation to said user; and
insert at least one offer related to said at least one target based on said at least one revenue opportunity prior to display said at least one recommendation to said user.

24. The system of claim 22, wherein said at least one recommendation comprises a location package including said at least one identified resident mobile contact having said at least one target.

25. The system of claim 16, wherein said server is further configured to:
facilitate a real-time communication session between said user and said at least one identified resident mobile contact having said at least one target in their at least one contact list; and
receive contact information associated with said at least one target from said at least one identified resident mobile contact, wherein said contact information is used to introduce said at least one target to said user during said real-time communication session.

26. The system of claim 25, wherein said real-time communication session comprises at least one online chat session.

27. The system of claim 25, wherein said server is further configured to reward said at least one resident mobile contact in response to said introduction of said at least one target to said user.

28. The system of claim 16, wherein said server is further configured to:
facilitate a non-real-time communication session between said user and said at least one identified resident mobile contact having said at least one target in their at least one contact list; and
receive contact information associated with said at least one target from said at least one identified resident mobile contact, wherein said contact information is used to introduce said at least one target to said user during said non-real-time communication session.

29. The system of claim 28, wherein said non-real-time communication session comprises at least one of offline chat session.

30. The system of claim 28, wherein said server is further configured to reward said at least one resident mobile contact in response to said introduction of said at least one target to said user.

31. A computer program product comprising computer executable program code recorded on a computer readable non-transitory storage medium, said computer executable program code when executed causing the actions including:
receiving at least one request from said user for introduction to at least one target;
identifying at least one resident mobile contact of said user having said at least one target in at least one contact list, wherein said at least one resident mobile contact is identified based on at least one tag associated with each mobile contact available in said at least one contact list of said resident mobile contact; and
recommending said at least one identified resident mobile contact having said at least one target to said user, wherein said recommendation is provided in accordance to at least one dynamic weight associated with each said resident mobile contact.

32. The computer program product of claim 31, wherein said computer executable program code when executed causing further actions including:
computing a degree of involvement of said user with each said resident mobile contact, wherein said degree of involvement is computed using at least one involvement parameter associated with said user;
assigning said dynamic weight to each said resident mobile contact based on said degree of involvement of said user with each said resident mobile contact; and
storing said at least one dynamic weight associated with each said resident mobile contact locally on an mobile device of said user.

33. The computer program product of claim 31, wherein said involvement parameter comprises at least one of: number of messages sent, number of messages received, number of interactions performed, proximity, location, success ratio, and circle of each said mobile contact.

34. The computer program product of claim 31, wherein said computer executable program code when executed causing further actions including:
identifying information associated with each said resident mobile contact;
automatically assigning said at least one tag to each said resident mobile contact based on said information; and
storing said at least one tag remotely on said server.

35. The computer program product of claim 31, wherein said computer executable program code when executed causing further actions including:
receiving a new mobile contact on said at least one contact list associated with said user;
computing a degree of similarity between said new mobile contact with each said mobile contact in at least one contact list of each said resident mobile contact, wherein said degree of similarity is computed using at least one similarity parameter associated with each said mobile contact in at least one contact list of said each said resident mobile contact; and
suggesting said at least one tag associated with said at least one contact in at least one contact list of said at least one resident mobile contact based on said degree of similarity.

36. The computer program product of claim 35, wherein said at least one similarity parameter comprises at least one of: proximity, said dynamic weight associated with each said resident mobile contact, success ratio, type of said at least one tag, and said circle of each said contact.

37. The computer program product of claim 31, wherein recommending said at least one identified resident mobile contact having said at least one target to said user comprising:
generating said at least one recommendation for said user, wherein said at least one recommendation comprises said at least one identified resident mobile contact having said at least one target;
sorting said at least one recommendation based on said at least one dynamic weight associated with said at least one identified resident mobile contact; and
displaying said at least one recommendation on said mobile device of said user.

38. The computer program product of claim 37, wherein recommending said at least one identified resident mobile contact having said at least one target to said user comprising:
identifying at least one revenue opportunity associated with said at least one target prior to displaying said at least one recommendation to said user; and
inserting at least one offer related to said at least one target based on said at least one revenue opportunity prior to displaying said at least one recommendation to said user.

39. The computer program product of claim 37, wherein said at least one recommendation comprises a location package including said at least one identified resident mobile contact having said at least one target.

40. The computer program product of claim 31, wherein recommending said at least one identified resident mobile contact having said at least one target to said user comprising:
facilitating a real-time communication session between said user and said at least one identified resident mobile contact having said at least one target in their at least one contact list; and
receiving contact information associated with said at least one target from said at least one identified resident mobile contact, wherein said contact information is used to introduce said at least one target to said user during said real-time communication session.

41. The computer program product of claim 40, wherein said real-time communication session comprises at least one online chat session.

42. The computer program product of claim 40 wherein said computer executable program code when executed causing further actions including rewarding said at least one resident mobile contact in response to said introduction of said at least one target to said user.

43. The computer program product of claim 31, wherein said computer executable program code when executed causing further actions including:
facilitating a non-real-time communication session between said user and said at least one identified resident mobile contact having said at least one target in their at least one contact list; and
receiving contact information associated with said at least one target from said at least one identified resident mobile contact, wherein said contact information is used to introduce said at least one target to said user during said non-real-time communication session.

44. The computer program product of claim 43, wherein said non-real-time communication session comprises at least one of offline chat session.

45. The computer program product of claim 43, wherein said computer executable program code when executed causing further actions including rewarding said at least one resident mobile contact in response to said introduction of said at least one target to said user.
